(19) United States
(12) Patent Application Publication
(10) Pub. No.: US 2009/0265103 A1
(43) Pub. Date: Oct. 22, 2009

(54) Vehicle Navigation System with Internet Based Information Search Feature

(75) Inventor: Hakan Kostepen, Peachtree City, GA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/148,063

(22) Filed: Apr. 16, 2008

(51) Int. Cl. G01C 21/00; G06F 17/30

(52) U.S. Cl. 701/213; 707/3; 707/E17.014

(57) ABSTRACT

A vehicle navigational system includes a processor generating a search query and transmitting a search query signal corresponding to the search query. A display unit receives the search query signal and displays a search query prompt in response to the search query signal. A user interface allows a user to enter search data into the processor in response to the search query prompt. A GPS communicator is communicatively coupled to the processor. The GPS communicator receives vehicle location data from a global positioning satellite and generates a vehicle location signal. A wireless communication device is communicatively coupled to the processor and allows the processor to communicate with the remote database. The processor initiates a search of the remote database based on the search data entered by user in response to the search query prompt, and based on the vehicle location signal. The processor receives results from the database and communicates the results to display unit for display.

### BACKGROUND OF THE INVENTION

1. Field of the Invention

The present invention relates to vehicle navigational systems.

2. Description of the Related Art

When traveling in a vehicle, the passengers often find themselves in unfamiliar areas making it difficult to locate the types of places that they are seeking. For instance, when traveling, a user may wish to stop at a certain type of restaurant to eat. Although government transportation departments have provided some signs along the highway alerting the traveler of some of the restaurants available at the upcoming exits, these signs do not reveal all of the available eateries. In addition, these signs are usually provided only on the major highways and interstates.

To assist travelers in navigating the roads, vehicles are sometimes equipped with a navigational system that may include a database full of maps. However, some of these systems do not include the locations of specific places, such as restaurants. Some navigational systems are linked to a global positioning system (GPS), which enables the user to see the location of his/her vehicle on the map. Some navigational systems are able to provide the use with directions as to how to get to specific locations already known and entered by the user. Unfortunately, these systems are not easily used to find unknown destinations.

What is neither disclosed nor suggested by the prior art is a system on-board a vehicle for identifying nearby establishments that are of a certain type that a user is seeking.

### SUMMARY

The present invention provides a system on-board a vehicle that wirelessly accesses a database search engine and provides search terms in the form of a vehicle location, as provided by a GPS, and in the form of a user-provided search term, such as a type of establishment or other data associated with the vicinity of the vehicle location. The system retrieves the search results from the search engine and presents the search results to a user within the vehicle.

In one embodiment, the present invention comprises a vehicle navigational method including displaying a search query prompt. At least one search term is entered in response to the search query prompt. Vehicle location data is received from a global positioning satellite. A search of a remote database is initiated. The search is based on the search term and based on the vehicle location data. Search results data are received from the database. The search results data is displayed. Each of the steps of the method is performed within the vehicle.

In another embodiment, the present invention comprises a vehicle navigational system including a processor that generates at least one search query and transmits a search query signal corresponding to the at least one search query. A display unit is communicatively coupled to the processor. The display unit receives the search query signal and displays a search query prompt in response to the search query signal. A user interface is communicatively coupled to the processor and allows a user to enter search data into the processor in response to the search query prompt. A GPS communication device is communicatively coupled to the processor and receives vehicle location data from a global positioning satellite. A wireless communication device is communicatively coupled to the processor and allows the processor to communicate with the remote database. The processor transmits the vehicle location data and the search data to the remote database and initiates a search of the remote database based on the search data and the vehicle location data. The processor receives results data from the database and communicates the results data to the display unit.

In yet another embodiment, the present invention comprises a vehicle navigational system including a processor that generates and transmits a keyword search query and a range-from-vehicle query. A display unit is communicatively coupled to the processor and receives the keyword and range-from-vehicles search queries. The display unit displays a keyword search query prompt and a range-from-vehicle search query prompt in response to respective the keyword and range-from-vehicle search queries. A user interface is communicatively coupled to the processor and allows a user to enter search data into the processor in response to the keyword and a range-from-vehicle search query prompts. A GPS communication device is communicatively coupled to the processor and is adapted to receive vehicle location data from a global positioning satellite. A wireless communication device is communicatively coupled to the processor and is adapted to allow the processor to communicate with the remote database. The processor transmits the vehicle location data and the search data to the remote database and initiates a search of the remote database based on the search data and the vehicle location data. The processor receives results data from the database and communicates the results data to the display unit.

An advantage of the present invention is that passengers of a vehicle may obtain information about establishments that are near the vehicle regardless of where the vehicle travels.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a diagram of a vehicle equipped with a navigational system in accordance with one embodiment of the present invention;

FIG. 2 is block diagram illustrating the communication between components of a navigational system in accordance with one embodiment of the present invention;

FIG. 3 is flow chart illustrating the steps of operation of a navigational system in accordance with one embodiment of the present invention; and

FIG. 4 is a flow chart illustrating one embodiment of a vehicle navigational method of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

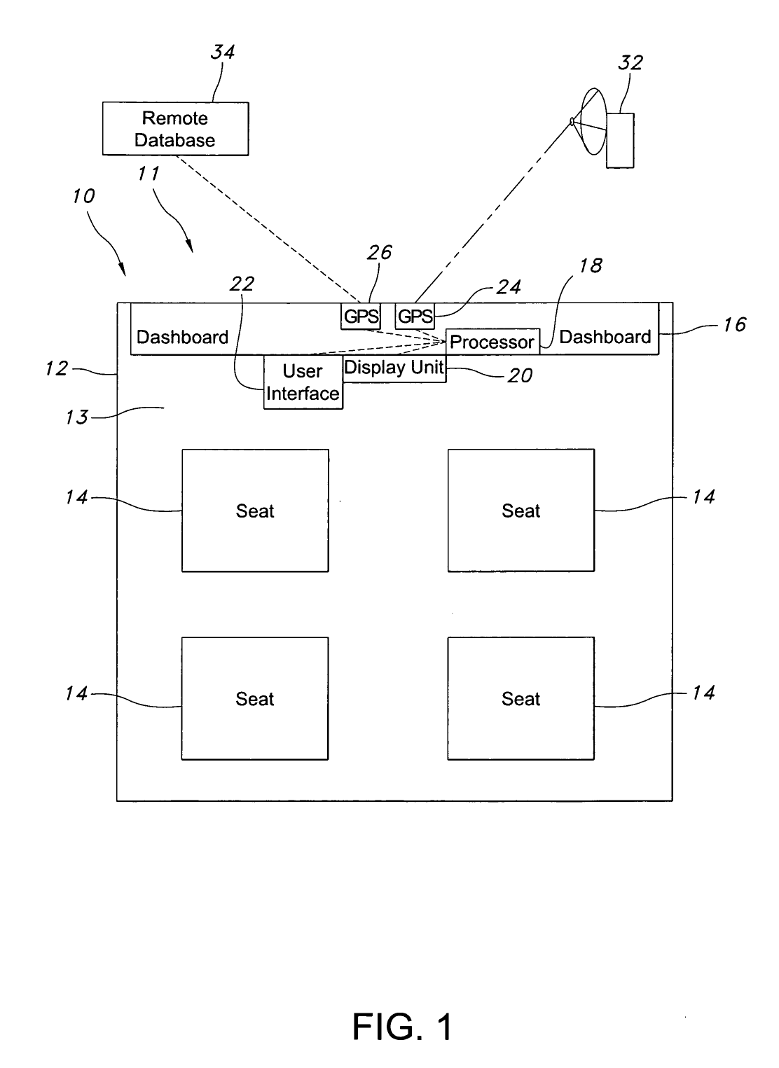

Referring first to FIG. 1, a vehicle 10 equipped with a navigational system 11 in accordance with one embodiment of the present invention is illustrated. Vehicle 10 generally includes a vehicle body 12 which defines a vehicle interior 13. Vehicle 10 also includes seats 14 disposed in vehicle interior 13. A dashboard 16 is disposed within vehicle interior 13 and extends along the front of vehicle body 12.

Navigational system 11 generally includes a processor 18 mounted in dashboard 16, a display unit 20 mounted on dashboard 16 and communicatively coupled to processor 18, a user interface 22 also mounted on dashboard 16 and communicatively coupled to processor 18, a global positioning system (GPS) communication device 24 mounted in dashboard 16 and communicatively coupled to processor 18, and a wireless communication device 26 mounted in dashboard 16 and communicatively coupled to processor 18.

Processor 18 is communicatively coupled to display unit 20, wireless communication device 26, user interface 22 and GPS communication device 24, as indicated by the dotted lines in FIG. 1. This communicative coupling may be accomplished via any known communication method including, for instance, standard wired connection, fiber optic connection and wireless connection. Processor 18 is adapted to transmit information to display unit 20. More particularly, processor 18 is adapted to generate search queries, as described in further detail below, and transmit the search queries to display unit 20 in a format that may be visually displayed on display unit 20 and viewed by a user. Processor 18 is also adapted to transmit and receive data to and from a search engine for a remote database, as described in further detail below, and display the data received on display unit 20. Processor 18 is also adapted to transmit and receive signals to and from a global positioning satellite, as described in further detail below. As described in further detail below, processor 18 is further adapted to communicate with a remote database, such as an internet web site, search engine, or other type of database interface.

In order to accomplish its tasks, processor 18 may be used in conjunction with, include and/or operate computer software programs such as navigational software and search software. Processor 18 may also be used in conjunction with and/or include a memory storage device, such as a hard drive and random access memory cards.

Display unit 20 is communicatively coupled to processor 18, and is capable of receiving data from processor 18 and displaying the data in visual form to be viewed by the user. Display unit 20 may be in the form of a monitor mounted on or in dashboard 16.

User interface 22 is communicatively coupled to processor 18 and is adapted to receive commands from the user. User interface 22 also enables the user to manipulate and respond to the data displayed on display unit 20. User interface 22 may be in any form suitable for allowing the user to operate processor 18 and manipulate data displayed on display unit 20. For instance, user interface 22 may include buttons, dials, scroll wheels, a keyboard, a touch pad, a voice recognition device, a mouse and/or other user interface devices. User interface 22 may be incorporated into display unit 20, such that display unit 20 may also serve as a touch screen for receiving user commands and information.

GPS communication device 24 is communicatively coupled to processor 18 and is adapted to transmit and receive information to and from a global positioning satellite. More particularly, GPS communication device 24 is adapted to receive vehicle location information from global positioning satellites 32 and communicate such information to processor 18. GPS communication device 24 may be any device suitable for communicating with a global positioning satellite.

Wireless communication device 26 is communicatively coupled to processor 18 and is adapted to transmit information to remote database 34 and receive information from remote database 34. In one embodiment, remote database 34 is a server housing a search engine capable of searching the internet. For instance, remote database 34 may be a search engine such as Google® or Yahoo®. Remote database 34 may also be a navigational website such as Mapquest®.

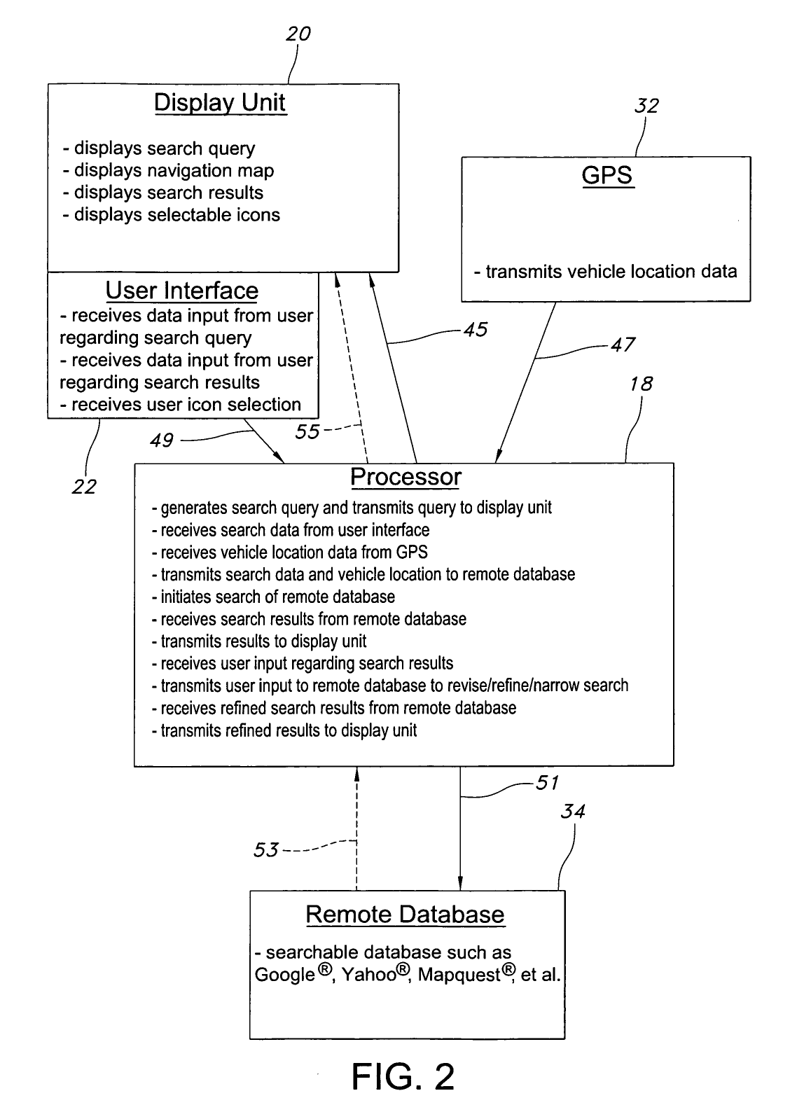

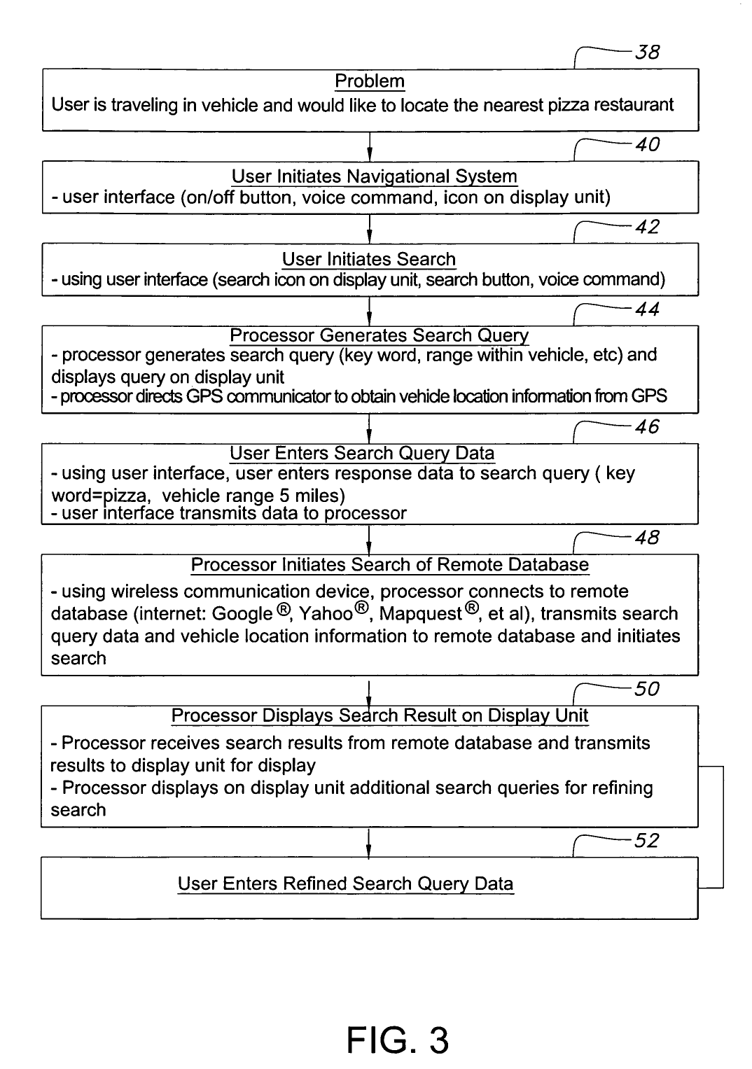

Referring now to FIGS. 2 and 3, the operation of a navigational system according to the present invention will now be described. For illustrative purposes, we assume that the user is traveling in vehicle 10 (FIG. 1) and would like to stop for dinner at a nearby pizza parlor. However, as shown in step 38, the problem is that the user is traveling in an area he/she is not familiar with and needs to locate the nearest pizza parlor. Using user interface 22, the user initiates the navigational system 11 (step 40). To enable this step 40, user interface 22 may be equipped with an on/off button, which the user may push to initiate the system. Alternatively, user interface 22 may include an icon on the touch screen portion of display unit 20, which the user touches to initiate the system. User interface 22 may be equipped with a voice recognition system that recognizes the user's voice. In this case, the user would simply call out a voice command such as “navigational system on” to initiate the system.

Next, the user initiates the search (step 42). As in the case of step 40, this may be accomplished by pressing a search button, engaging a search icon on display unit 20 or calling out a voice command. Initiation of the search causes processor 18 to generate at least one search query and transmit the search query (step 44), in the form of a search query signal, to display unit 20, as indicated by arrow 45 in FIG. 2. The search query may be in the form of any question useful in searching for the information desired by the user. For instance, the search query may be a keyword query that prompts the user to enter a keyword or keywords relating to the subject of the search. For example, the user may enter the word or words “pizza,” “restaurant,” or other useful words. The user may enter the name of a known pizza chain such as “Pizza Hut®.” Processor 18 may generate multiple search queries. For instance, in addition to a keyword query, processor 18 may generate a range-from-vehicle query. This query would prompt the user to enter in a number representing the distance from the vehicle in which the user would like to locate a pizza restaurant. For instance, the user may enter the number “5” to indicate that the search engine should look in a five mile radius from the vehicle. Processor 18 may be adapted to generate any query useful in conducting a search.

The user may also enter two or more number representing different thresholds of the distance from the vehicle, and the search engine may categorize the search results according to these numerical thresholds. For example, the user may enter the numbers “5” and “10” to indicate that the search engine should look for establishments in a first category that are less than five miles from the vehicle, and in a second category that are between five and ten miles from the vehicle.

As shown in step 44, upon initiation of the search 42, processor 18 directs GPS communicator 24 to retrieve vehicle location information from global positioning satellites. Processor 18 directs GPS communicator 24 to receive vehicle location information signals (arrow 47) from the global positioning satellites. GPS communicator 24 then communicates the vehicle location information signal to processor 18.

Referring still to FIGS. 2 and 3, as illustrated in step 46, the user enters search query data in response to the search queries generated by processor 18 and displayed on display unit 20. For instance, using user interface 22, the user may enter the keyword “pizza” and the distance “5 miles.” This may be accomplished by using a touch screen keyboard provided on display unit 20. Alternatively, as noted above, user interface 22 may include a keyboard or other data entry device into which the user may enter the search query data. As indicated by arrow 49, user interface 22 may then communicate to processor 18 the search query data, i.e., one or more search terms, that the user entered in response to the search query.

As shown in step 48, using wireless communication device 26 (FIG. 1), processor 18 communicates the search query data entered by user, along with the vehicle location as calculated from the vehicle location data received from the global positioning satellite, to remote database 34 (FIG. 1) and initiates a search, as illustrated by arrow 51 in FIG. 2. In this particular example, processor 18 sends the keyword data “pizza” and “5 mile radius from vehicle”, along with the calculated vehicle location data to remote database 34 (FIG. 1). Remote database 34 (FIG. 1) performs the search and, via wireless communication device 26 (FIG. 1), remote database 34 (FIG. 1) transmits the search results to processor 18, as illustrated by arrow 53.

As shown in step 50, processor 18 then displays the search results on display unit 20 (see arrow 55 in FIG. 2). The display results may be in the form of a map having the locations of pizza parlors within a 5 mile radius of the vehicle marked on the map with marker (dot, arrow or other marker). Alternatively, or in addition, the display results may include directions and/or contact information (address and phone number) of the pizza parlors revealed in the search. The display results may also include additional tools for refining the results, such a zoom tools and/or directional tools. Furthermore, the display results may be layered on top of current navigational information. For instance, display unit 20 may display a map with the location of the vehicle represented on the map. The search results may be layered on top of this map such that the location of the vehicle relative to the location of the identified pizza parlors is displayed. The navigational system enables a traveler to quickly and easily locate desired places relative the vehicle's present location.

As shown in step 52, the user may then refine the search further by entering additional information in the search query and/or entering zoom commands. After entering refined search query data, steps 48-50 are repeated to yield refined search results.

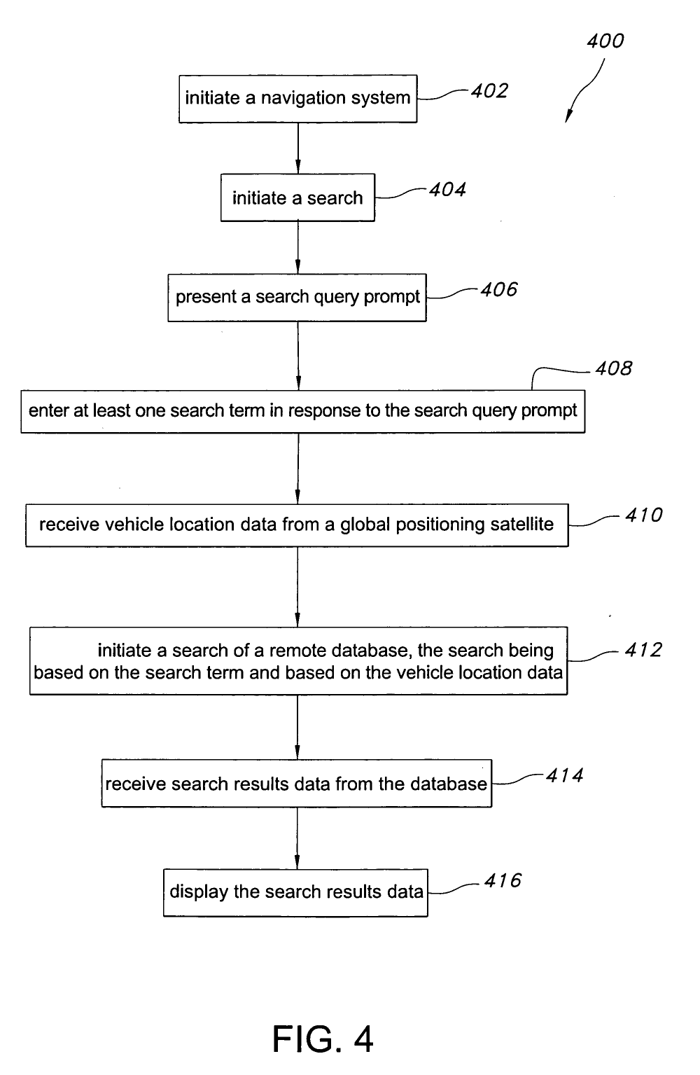

FIG. 4 illustrates one embodiment of a vehicle navigational method 400 of the present invention in which all of the steps are performed within the vehicle. In a first step 402, a user initiates a navigation system. For example, a user may speak a voice command or press a button or icon on a dashboard or display to initiate the navigation system. In a next step 404, the user initiates an internet-based search for information about the vehicle's nearby environment. Again, a user may speak a voice command or press a button or icon on a dashboard or display to initiate the search. Next, a search query prompt is presented in step 406. For example, a question mark or blank field may be provided on a display. Alternatively, a system-generated voice may audibly ask a user for a search term. In step 408, at least one search term is entered in response to the search query prompt. For instance, a user may type or speak “library” or “weather conditions”. Vehicle location data may be received from a global positioning satellite in a next step 410. That is, the vehicle may include a GPS system that receives signals from multiple satellites, and the GPS system may calculate the vehicle's global location based on the received signals. Next, in step 412, a search of a remote database is initiated, the search being based on the search term and based on the vehicle location data. For example, the navigation system may use a wireless internet connection to access an internet search engine. The user-specified search term as well as the calculated vehicle location may be wirelessly transmitted as search terms. In a next step 414, search results data are received from the database. That is, after the search engine performs a search based on the search term(s) and the vehicle location, the search results data is wirelessly transmitted to the vehicle, and the search results data is received within the vehicle. For example, the search results data may include a list of libraries or weather conditions near the vehicle's location. In a final step 416, the search results data is displayed. For example, a list of libraries or weather conditions may be displayed on a LED display, LCD display or monitor within the passenger compartment of the vehicle.

The present invention has been described herein as being used to locate pizza restaurants within a certain distance from the vehicle. However, it is to be understood that the present invention may be used to identify any desired type of establishment that is within a certain distance from the vehicle. For example, the present invention may be used to locate gas stations and hospitals. It is also possible for the invention to retrieve information about the establishments, such as the current gas prices at the various gas stations, hours of operation, etc.

It is also within the scope of the invention to retrieve information about the nearby environment of the vehicle that does not relate to any type of establishment. For example, the invention could be used to retrieve information about local weather conditions, such as the current temperature and a display of the local weather radar.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A navigational method for a vehicle, comprising the steps of:
presenting a search query prompt;
entering at least one search term in response to the search query prompt;
receiving vehicle location data from a global positioning satellite;
initiating a search of a remote database, the search being based on the search term and based on the vehicle location data;
receiving search results data from the database; and
displaying the search results data, wherein each of the steps of the method is performed within the vehicle.

2. The vehicle navigational method of claim 1 wherein the user enters the at least one search term via a user interface.

3. The vehicle navigational method of claim 1 wherein the at least one search term comprises a keyword.

4. The vehicle navigational method of claim 1 wherein the at least one search term comprises a range-from-vehicle.

5. The vehicle navigational method of claim 4 wherein the search term describes a type of retail establishment.

6. The vehicle navigational system of claim 5 wherein a search engine provides the search results data, the search results data identifying at least one retail establishment of a type described by the search term and disposed within the range-from-vehicle included in the search term.

7. The vehicle navigational method of claim 1 wherein a user initiates a search before the at least one search query is generated.

8. The vehicle navigational method of claim 1 wherein the user initiates a navigation system before the at least one search query is generated.

9. A vehicle navigational system for extracting information from a remote database, the system comprising:
a processor adapted to:
generate at least one search query; and
transmit a search query signal corresponding to the at least one search query;
a display unit communicatively coupled to the processor, the display unit being configured to:
receive the search query signal; and
display a search query prompt in response to the search query signal;
a user interface communicatively coupled to the processor, the user interface adapted to enable a user to enter search query data into the processor in response to the search query prompt;
a GPS communication device communicatively coupled to the processor and adapted to receive vehicle location data from a global positioning satellite; and
a wireless communication device communicatively coupled to the processor, the wireless communication device adapted to allow the processor to communicate with the remote database;
wherein the processor is configured to:
calculate a vehicle location based on the vehicle location data;
transmit the vehicle location and the search data to the remote database;
initiate a search of the remote database based on the search data and the vehicle location;
receive results data from the database; and
communicate the results data to the display unit.

10. The vehicle navigational system of claim 10 wherein the display unit displays the results data, and the user interface and the processor cooperate to allow the user to further navigate the displayed results data.

11. The vehicle navigational system of claim 10 wherein the at least one query includes a range-from-vehicle query and the search data includes a range-from-vehicle.

12. The vehicle navigational system of claim 10 wherein the at least one query includes a keyword query and the search data includes a keyword.

13. The vehicle navigational system of claim 12 wherein the at least one query further includes a range-from-vehicle query and the search data further includes a range-from-vehicle.

14. The vehicle navigational system of claim 10 wherein the user interface includes a keyboard.

15. The vehicle navigational system of claim 10 wherein the user interface includes a touch screen built into the display unit.

16. The vehicle navigational system of claim 10 wherein the user interface includes a voice recognition device coupled to the processor.

17. A vehicle navigational system for extracting information from a remote database, the system comprising:
a processor generating and transmitting a keyword search query and a range-from-vehicle query;
a display unit communicatively coupled to the processor, the display unit receiving the keyword and range-from-vehicle search queries, the display unit displaying a keyword search query prompt and a range-from-vehicle search query prompt in response to the keyword and range-from-vehicle search queries, respectively;
a user interface communicatively coupled to the processor, the user interface adapted to allow a user to enter keyword and range-from-vehicle search data into the processor in response to the keyword and a range-from-vehicle search query prompts;
a GPS communication device communicatively coupled to the processor and adapted to receive vehicle location data from a global positioning satellite; and
a wireless communication device communicatively coupled to the processor, the wireless communication device adapted to allow the processor to communicate with the remote database;
wherein the processor is configured to:
calculate a vehicle location based on the vehicle location data;
transmit the vehicle location and the search data to the remote database;
initiate a search of the remote database based on the keyword and range-from-vehicle search data and the vehicle location;
receive results data from the database; and
communicate the results data to the display unit.

18. The vehicle navigational system of claim 17 wherein the user interface and the processor cooperate to enable the user to further navigate the displayed results data.

19. The vehicle navigational system of claim 17 wherein the user interface includes a keyboard.

20. The vehicle navigational system of claim 17 wherein the user interface includes a touch screen built into the display unit.
